(19) United States
(12) Patent Application Publication
(10) Pub. No.: US 2024/0365357 A1
(43) Pub. Date: Oct. 31, 2024

(54) RESOURCE ALLOCATION SCHEMES FOR SIDELINK COMMUNICATIONS

(71) Applicant: ZTE Corporation, Shenzhen (CN)

(72) Inventors: Junpeng LOU, Shenzhen (CN); Chuangxin JIANG, Shenzhen (CN); Jie CHEN, Shenzhen (CN); Mengzhen LI, Shenzhen (CN); Focai PENG, Shenzhen (CN); Zhiqiang HAN, Shenzhen (CN); Qi YANG, Shenzhen (CN)

(21) Appl. No.: 18/767,731

(22) Filed: Jul. 9, 2024

Related U.S. Application Data
(63) Continuation of application No. PCT/CN2023/090118, filed on Apr. 23, 2023.

(51) Int. Cl. H04W 72/52; H04W 72/044; H04W 72/40

(52) U.S. Cl. CPC H04W 72/52; H04W 72/046; H04W 72/40

(57) ABSTRACT

A method of wireless communication is provided. The method comprises: receiving, by a first device, based on a receiving beam information, a first sidelink transmission; selecting, based on selection information, a resource set for a second sidelink transmission; and sending, to a second device, the second sidelink transmission based on transmitting beam information.

### TECHNICAL FIELD

This document relates to systems, devices and techniques for wireless communications.

### BACKGROUND

Wireless communication technologies are moving the world toward an increasingly connected and networked society. The rapid growth of wireless communications and advances in technology has led to greater demand for capacity and connectivity. Other aspects, such as energy consumption, device cost, spectral efficiency, and latency are also important to meeting the needs of various communication scenarios. In comparison with the existing wireless networks, next generation systems and wireless communication techniques need to provide support for an increased number of users and devices, as well as support an increasingly mobile society.

### SUMMARY

Various methods and apparatus for providing resource allocation schemes for sidelink communications are provided.

In one example aspect, a method of wireless communication is disclosed. The method includes receiving, by a first device, based on a receiving beam information, a first sidelink transmission; selecting, based on selection information, a resource set for a second sidelink transmission; and sending, to a second device, the second sidelink transmission based on transmitting beam information.

In yet another example aspect, a wireless communications apparatus comprising a processor is disclosed. The processor is configured to implement methods described herein.

In another example aspect, the various techniques described herein may be embodied as processor-executable code and stored on a computer-readable program medium.

The details of one or more implementations are set forth in the accompanying drawings, and the description below. Other features will be apparent from the description and drawings, and from the claims.

### BRIEF DESCRIPTION OF THE DRAWINGS

FIG. 1 shows an example diagram showing resource allocation for mode line FR2 based on some implementations of the disclosed technology.

FIG. 2 shows an example diagram showing a sensing operation and a transmitting operation based on a transmitting beam based on some implementations of the disclosed technology.

FIG. 3 shows an example diagram showing a sensing operation based on a receiving beam group and a transmitting operation based on a transmitting beam based on some implementations of the disclosed technology.

FIG. 4 shows an example diagram showing a sensing operation and a transmitting operation based on a transmitting beam group based on some implementations of the disclosed technology.

FIG. 5 shows an example diagram showing a sensing operation based on a receiving beam group and a transmitting operation based on a transmitting beam group based on some implementations of the disclosed technology.

FIG. 6 shows an example diagram showing a resource selection based on a conflict level of time and frequency resources based on some implementations of the disclosed technology.

FIG. 7 shows another example diagram showing a resource selection based on a conflict level of time and frequency resources based on some implementations of the disclosed technology.

FIG. 8 shows an example of a spatial relationship of Beam 1 and Beam 2 based on some implementations of the disclosed technology.

FIG. 9 shows an example of narrow beams and wide beams based on some implementations of the disclosed technology.

FIG. 10 shows an example wireless communications network based on some implementations of the disclosed technology.

FIG. 11 is a block diagram of an example of a wireless communication apparatus based on some implementations of the disclosed technology.

FIG. 12 is an example flowchart of a wireless communication method based on some implementations of the disclosed technology.

### DETAILED DESCRIPTION

The disclosed technology provides implementations and examples of resource allocation schemes for sidelink transmissions.

The technologies related to sidelink transmissions are developing fast. Based on the latest discussion progress, FR2 (Frequency Range 2) is a hot topic for sidelink transmissions and how to improve the SL (sidelink)-PRS (positioning reference signal) and other signal/channel transmission and reception for sidelink positioning in FR2 are being studied. For the resource allocation of SL-PRS in FR2, the beam management needs to be considered. In addition, the impact of the beam information for the resource allocation method (e.g., mode1 and/or mode2) needs to be considered as well.

The legacy resource allocation methods are based on the time-frequency resources in the resource pool without considering the actual beam effect. Thus, the legacy methods ignore the effect of space on the time-frequency resources. For example, in the resource allocation for mode 2 sidelink transmissions, the transmitting UE cannot judge the spatial beam information of the time-frequency domain resources sent by another UE. According to the legacy methods, there are limitations on the information that the transmitting UE receives regarding the beam information. In fact, according to the legacy methods, any beam related information is not provided to the transmitting UE and the transmitting UE selects the resource allocation independently from the beam information.

Various implementations of the disclosed technology provide resource allocation techniques for sidelink transmissions. Some implementations of the disclosed technology are related to how to perform the resource allocation under FR2 for sidelink transmissions and how to perform sensing procedures under FR2 for sidelink transmissions. The implementations resolve the currently existing problems for sidelink transmissions in FR2, for example, SL-PRS in SL positioning.

The PRS of NR position has been approved, e.g., RAN #94 for Rel-18 positioning. The sidelink of SI has been approved, e.g., RAN #94 for Rel-18 positioning as follows:
Study and evaluate performance and feasibility of potential solutions for SL positioning, considering relative positioning, ranging and absolute positioning: [RAN1, RAN2]
   Evaluate bandwidth requirement needed to meet the identified accuracy requirements [RAN1]
   Study of positioning methods (e.g. TDOA, RTT, AOA/D, etc.) including combination of SL positioning measurements with other RAT dependent positioning measurements (e.g. Uu based measurements) [RAN1]
   Study of sidelink reference signals for positioning purposes from physical layer perspective, including signal design, resource allocation, measurements, associated procedures, etc., reusing existing reference signals, procedures, etc. from sidelink communication and from positioning as much as possible [RAN1]
   Study of positioning architecture and signalling procedures (e.g. configuration, measurement reporting, etc.) to enable sidelink positioning covering both UE based and network based positioning [RAN2, including coordination and alignment with RAN3 and SA2 as required]

In this patent document, the higher layer corresponds to at least one of RRC layer, SL LPP, PC5-RRC, PC5-S, MAC layer or application layer, and the physical layer corresponds to 1-st SCI, 2-ed SCI, SCI for SL-PRS or MAC CE.

In some implementations, beam, beam information, or beam direction have the same or similar concept, which includes at least one of the following: QCL (quasi co-location) state, TCI (transmission configuration indication) state, spatial relationship information, reference signal information, spatial filter information, and precoding information.

In the implementations, beam/beam direction can be a resource. For example, a transmitter spatial filter, a receiver spatial filter, a transmitter precoding, a receiver precoding, an antenna port, an antenna weight vector, or an antenna weight matrix can all be used as beams.

The parameters of QCL include at least one of the following: Doppler shift, Doppler spread, average delay, delay spread, average gain, spatial parameters (spatial Rx parameter), or spatial relationship information.

The beam can support for various transmission or reception methods which include at least one of the following: space division multiplexing or frequency domain/time domain diversity. The transmitted beam or transmission method can be indicated by a reference signal resource index or a spatial relationship index.

The beam or transmission or reception method of a transmission is determined based on the reference signal resource index. Thus, the transmission or reception filter parameters of the transmission are the same as the transmission or reception filter parameters of the reference signal resource indicated by the reference signal resource index.

The spatial relationship may be indicated by reference signals. Thus, the spatial relationship index can also be a reference signal index. The transmitted beam or transmission or reception method is determined based on the reference signal resource index, which means that the demodulated reference signal of the transmission and the reference signal indicated by the reference signal resource index have the same QCL parameters.

Spatial parameters include spatial reception parameters, such as angle of arrival, spatial correlation of received beams, average delay, and correlation of time-frequency channel responses (including phase information).

The spatial relationship for a certain CH/RS, such as SL-PRS in dedicated resource pool, can be relied on the resource pool ID, slot ID, CSI-RS ID, the PSSCH/SL-PRS resource and the pool ID or other combinations of these ID or resource(s).

The channels/reference signals (CH/RS) include at least one of the following: PSFCH, PSSCH, PSCCH, S-SSB, Physical Downlink Shared Channel (PDSCH), Physical Downlink Control Channel (PDCCH), PRS, SL-PRS, Channel State Information Reference Signal (CSI-RS), Channel State Information Interference Measurement Signal (CSI-IM), Demodulation Reference Signal (DMRS), Downlink Demodulation Reference Signal (DL-DMRS), PSCCH DMRS, PSSCH DMRS, Sidelink CSI-RS, Uplink Demodulation Reference Signal, UL DMRS, Sounding Reference Signal (SRS), Phase-Tracking Reference Signals (PTRS), Random Access Channel (RACH), Synchronization Signal (SS), Synchronization Signal Block (SSB or S-SSB), Primary Synchronization Signal (PSS), Secondary Synchronization Signal (SSS, SL-PSS, or SL-SSS), or PSBCH DMRS.

The beam can be transmitted from LMF (Location Management Function) to BS, and/or BS to UE, and/or UE to BS, and/or BS to BS, and/or UE to LMF, and/or UE to UE. And the beam info can be contained in higher layer (at least one of RRC layer, SL LPP, PC5-RRC, PC5-S, MAC layer or application layer) or physical layer (1-st SCI, 2-ed SCI, SCI for SL-PRS or MAC CE).

In the description below, section headings are used in the present document only to improve readability and do not limit scope of the disclosed embodiments and techniques in each section only to that section. Furthermore, some embodiments are described with reference to Third Generation Partnership Project (3GPP) New Radio (NR) standard (“5G”) for ease of understanding and the described technology may be implemented in different wireless system that implement protocols other than the 5G protocol.

### Resource Allocation Mode 1 in FR2

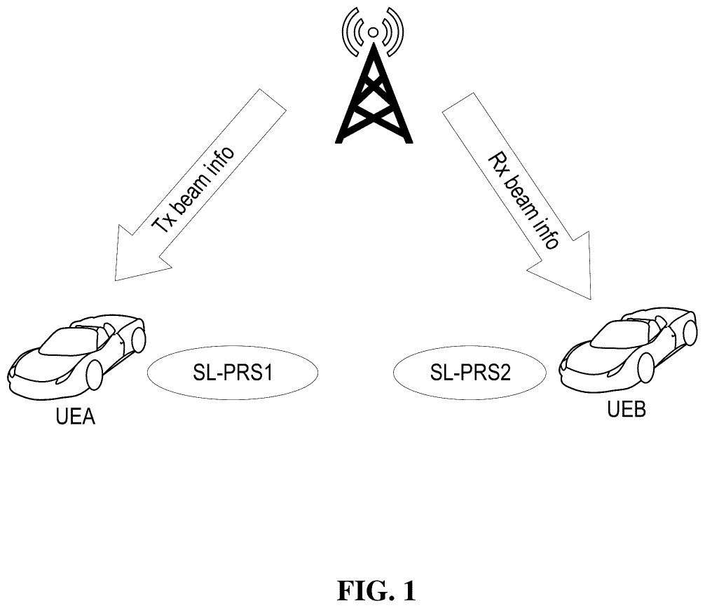

In general, two sidelink resource allocation modes are supported, i.e., Mode 1 and Mode 2. In Mode 1, a sidelink resource in time and frequency domains allocation is provided by a network (e.g., a base station). FIG. 1 shows an example diagram showing mode 1 resource allocation method in FR2 based on some implementations of the disclosed technology. In this implementation, the base station (BS) has the beam information of transmitting UE and the receiving UE, as well as the beam information of other UE(s) covered by the BS. In addition, the BS determines the resources allocation in time-frequency domain for the UEs. In this example, the resource allocation for receiving and transmitting beams and time-frequency domain resources can be flexibly adjusted, and the unnecessary resource waste can be avoided.
Case 1: For Mode 1 SL-PRS transmission in FR2, based on the resource allocation mode of mode1, the base station provides the transmitter beam information (Tx beam info) to the transmitting UE (TxUE) and provides the receiver beam information (Rx beam info) to the receiving UE (RxUE). In the example, the DCI 3-0 can be used to provide the beam information.
Case 2: For Mode 1 SL-PRS transmission in FR2, the base station provides the transmitter beam information (Tx beam info) to the transmitting UE (TxUE) and the transmitting UE (TxUE) provides the receiver beam information (Rx beam info) to the receiving UE (RxUE). In this example, the next beam direction can be indicated in SCI (Sidelink Control Information). When a message or a channel (e.g., SL-PRS, PSSCH) is transmitted from a transmitting UE to a receiving UE, the transmitting UE will send the SCI and the receiving UE receive the SCI. The receiving UE can identify the resource area of the message or the channel based on the SCI.
Case 3: For Mode 1 SL-PRS transmission in FR2, the base station provides the transmission beam information (Tx beam info) to the transmitting UE (TxUE). The following two cases can be implemented:
   Case 3-1: RxUE performs the beam scanning to get the receiver beam information. In this example, the SCI can be used to cause the RxUE to perform the beam sweeping.
   Case 3-2: The RxUE can receive beams in all directions with omnidirectional antenna.

The beam can be transmitted from LMF to the base station, and/or the base station to UE, and/or UE to the base station, and/or base station to another base station, and/or UE to LMF, and/or UE to another UE. The beam information can be contained in a higher layer (at least one of RRC layer, SL LPP, PC5-RRC, PC5-S, MAC layer or application layer) or physical layer (1-st SCI, 2-ed SCI, SCI for SL-PRS or MAC CE).

In the implementations, the UE can forward, transmit, and/or receive the beam information based on the UE capability. For example, a UE only can transmit the beam information to the base station and/or to LMF, and/or another UE or combine of them. These UE capabilities need to be indicated using an indicator.

### Resource Allocation Mode 2 in FR2

In Mode 2, a UE decides sidelink transmission resource(s) in time and frequency domains in a resource pool.

### Beam Information

In this implementation, the higher layer of the UE triggers the UE to perform a sensing procedure. To perform the sensing procedure, the higher layer may provide beam information at the trigger time slot n. Here, the higher layer is the higher layer applied to the UE performing the sensing procedure. The UE performs the sensing procedure based on the beam information and selects a subset of resources for the sidelink transmission. After the sensing procedure, the UE reports a subset of resource to the higher layer from which the higher layer will select resources for a the sidelink transmission. The sidelink transmission may correspond to transmissions of reference signals (RSS), channels (CHs), data etc. In the FR2, the UE transmits the sidelink transmission based on one or more beams. Thus, unlike the sensing under the legacy resource allocation schemes, the sensing procedure under resource allocation mode 2 in FR2 needs to consider the influence of the beams for the resource allocations. The one or more beams have corresponding directions and the directions of the beams may be referred to as the beam information. The beam information can be obtained in various manners. In some implementations, at the trigger time slot n, the higher layer provides the beam information for the resource allocation. In some implementations, the beam information can come from Tx UE or coordination UE (including RX UE).

For the mode 2 resource allocation of FR2, when taking the SL-PRS resource allocation as an example, the beam information can be provided from the higher layer. The beam information includes Tx beam information (Tx beam info) and Rx beam information (Rx beam info). In some implementations, the Tx beam information refers to the beam information used by a UE for its transmitting operation. Thus, for each of the transmitting UE (TxUE) and the receiving UE (RxUE), the Tx beam information can be used for its transmitting operation. In some implementations, the Rx beam information refers to the beam information used by a UE for its receiving operation. Thus, for the transmitting UE (TxUE), the Rx beam information refers to the beam information used by the transmitting UE (TxUE) for its receiving operation. For the receiving UE (RxUE), the Rx beam information refers to the beam information used by the receiving UE (RxUE) for its receiving operation. In the examples, the transmitting and/or receiving by the transmitting UE may refer to the operation to transmit and/or receive signals, information, channels, etc. In this document, signals, information, channels, etc., may be referred to as data.

In resource allocation mode 2, the higher layer can request the UE to determine a subset of resources from which the higher layer will select resources for SL-PRS transmission. To trigger this procedure, in slot n, the higher layer provides the following parameters for this PSSCH/PSCCH transmission:
the resource pool from which the resources are to be reported;
the frequency domain index of SL-PRS;
optionally, (Tx and/or Rx) beam info;
L1 priority, prio_{TX};
the remaining SL-PRS delay budget;
the number of comb offset to be used for the SL-PRS transmission in a slot;
the resource reservation interval, P_{rsvp_TX}, in units of msec.
panel ID

Although the table above shows that Tx beam information and Rx beam information are provided from the higher layer, other implementations are also possible such that the Tx beam information and Rx beam information are provided in various manners others than the higher layer. In some implementations, other items included in the table above can also be provided through various manners without being limited from the higher layer. Depending on from which Tx beam information and/or Rx beam information is provided, the following cases can occur.
Case 1: The Tx beam information and/or Rx beam information comes from the Tx/sensing UE based on the physical layer.
Case 2: The Tx beam information and/or Rx beam information comes from another UE (Rx UE or coordination UE) based on the higher layer transmission.
Case 3: The Tx beam information and/or Rx beam information comes from another UE (Rx UE or coordination UE) based on the lower layer transmission.

In some implementations of the disclosed technology, the TxUE receives various message/information/channels according to some configured beam information. The TxUE performs resource selection on the message/information/channel to be transmitted based on the configured beam information and selection information. TXUE send the message and/or information and/or channel(s) based on a beam to a RxUE.

In some implementations, the TxUE is (pre-) configured with a beam direction for transmitting the message/information/channel(s) to another UE. Then, based on the beam information and the selection information, which are obtained from high-level configuration or physical layer, the TxUE performs resource selection according to various messages/information/channels received in the sensing window.

In some implementations, the TxUE receives various messages/information/channels according to some configured beam information. Further, sub-weight refinement is performed to be received in the sensing window according to the configured beam. The TxUE receives various messages/information/channels according to certain configured beam information.

The sidelink transmission includes the transmission of a signal and/or data or channel, such as PSCCH, PSSCH, PSFCH, SL-PRS, SCI to indicated SL-PRS, DMRS, CSI-RS.

### Resource Selection Based on Beam Information

For the resource allocation mode 2 of FR2, one or more sensing beams have relation(s) with the Tx beam(s). There are certain association relationships between the one or more sensing beams and the resource allocation.

The transmitting UE (TxUE) receives a message based on the sensing beams with the different directions in a sensing window, in physical layer. The set A (a subset of the resources for the sidelink transmission) is obtained based on the selection procedure and is provided to its higher layer. The selection procedure is based on the resource exclusion with the reservations of the resource obtained in the sensing window. Depending on which direction beams the UE uses to obtain the set A, following cases can occur.
Case 1: All the directions are used to get the set A.
Case 2: Partial directions are used to get the set A.

In some implementations, the partial directions have some relationship with the transmission beam (Tx beam). For example, the partial directions correspond to transmission beam (Tx beam) direction(s) or the opposite beam direction(s) with the Rx Beam Group (RBG) or others. In some implementations, the partial directions correspond to directions perpendicular to propagation directions.

For Case 1, the transmitting UE (TxUE) performs the sensing procedure based on all the direction beams or wide beams. The UE performs the resource selection procedure based on the sensing results. The transmitting UE (TxUE) can detect the conflicts in the sensing window and obtain the set A. For case 2, the sensing related beam information can be also referred to as the receiving beam. The receiving beam for case 1 means all the received beams. The receiving beam for case 2 can be partial received beams.

For FR2, there are some resource transmissions with certain directions that would not be in the conflict. Examples 1-4 below discuss the sensing procedures without considering the time/frequency resources, while Examples 5 and 6 below discuss the sensing procedures based on the time/frequency resources. The sensing procedures in the Examples 1-4 involve more conflicts between beam directions, while the sensing procedures in the Examples 5 and 6 involve less conflicts between beam directions. In the examples below, the sensing by the transmitting UE (TxUE) is mainly discussed without other UE's sensing.

### Example 1—Sensing Procedure and Transmission of SL-PRS1 Based on Tx Beam

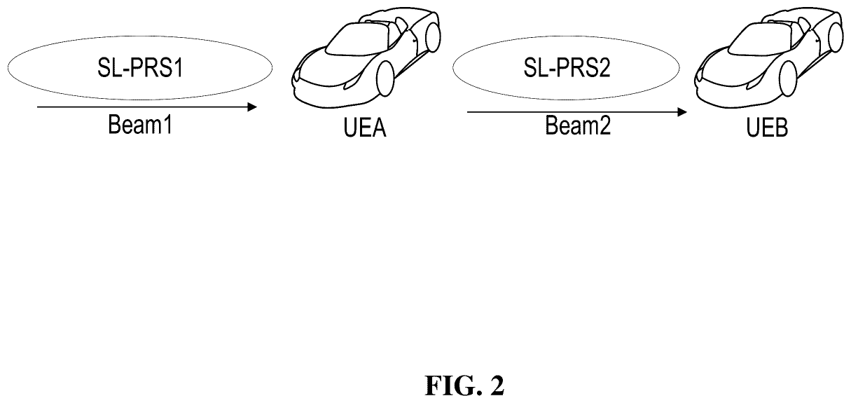

In this example, the sensing beam adopts one direction and the transmitting beam adopts one direction. Thus, the sensing beam and the transmitting beam have a 1:1 relationship. In this example, the transmitting UE (TxUE) operates based on the Tx beam information and is (pre-) configured with the direction of a Tx beam to RxUE. The transmitting UE (TxUE) proceeds the sensing procedure with sensing beam. The sensing beam may have a direction that is same or opposite or in another relationship with regard to the Tx beam direction. For example, as shown in FIG. 2, the transmitting UE (UEA) wants to send SL-PRS2 to another UE (UEB) with the beam 2 direction that is from UEA to the UEB. Before sending SL-PRS2, the transmitting UE (UEA) proceeds the sensing procedure with the beam 1 direction. Based on the sensing procedure with the beam 1 direction, the transmitting UE (UEA) can determine if there are conflicts in time-frequency domain resources for the UEB with the beam direction coming from UEA (Beam 2 direction).

The transmitting UE (UEA) selects the resources for SL-PRS2 with the beam 2 direction based on the received resources with the beam 1 direction in the sending window. As shown in FIG. 2, the transmitting UE (UEA) receives the SL-PRS1 in the sensing window with the beam 1 direction and the reserved resource of SL-PRS1 is obtained in the selection window. Then, the UEA avoids the conflict with the reserved resource of SL-PRS1 for the resource selection of SL-PRS2 in the selection window.

### Example 2—Sensing Procedure Based on Rx Beam Group and Transmission of SL-PRS1 Based on Tx Beam

In this example, the sensing beam adopts multiple directions, and the transmitting beam adopts one direction. Thus, the sensing beam and the transmitting beam have a N:1 relationship. In this example, the transmitting UE (TxUE) operates based on the Tx beam information and is (pre-) configured with the direction of the Tx beam to RxUE (Beam2 direction). Then, the transmitting UE (TxUE) uses the same as and/or the opposite to beam direction and/or the one or more nearby beam directions of them to perform the sensing and/or selection procedure. Thus, in this example and other examples, the sensing beam(s) can have one or more directions, which include same or opposite direction of the configured beam direction, directions of nearby beams of the same or opposite direction of the configured beam directions, etc.

The one or more nearby Rx beams can be referred to as RBG (Rx Beam Group) which contain N Rx beams and have similar spatial relations one each other. The sensing procedure can be based on the Rx Beam Group. Since the RBG includes multiple beams, the sensing procedure can be considered as being based on the wide beams. Different and/or same wide beams can be contained in a RBG. The beams in a RBG can be overlapped in space.

The RBG can be transmitted from LMF to the base station, and/or the base station to UE, and/or UE to the base station, and/or the base station to another base station, and/or UE to LMF, and/or UE to UE. The RBG can be defined or (pre-) configured in the higher layer (at least one of RRC layer, SL LPP, PC5-RRC, PC5-S, MAC layer or application layer) or physical layer (1-st SCI, 2-ed SCI, SCI for SL-PRS or MAC CE).

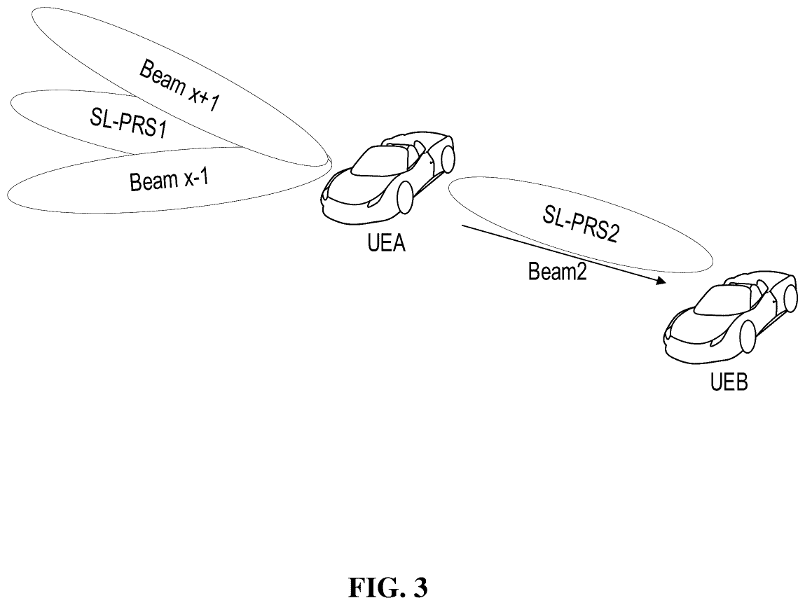

For example, referring to the example shown in FIG. 3, the transmitting UE (UEA) sends the SL-PRS2 to the receiving UE (UEB) with the beam 2, and the receiving UE (UEB) is not in the center of beam 2. In FIG. 3, the beam X+1, beam X, Beam X−1 are the RBG used for sensing. The beam X is used for transmitting SL-PRS1. When the transmitting UE (UEA) proceeds the sensing procedure with the RBG, the conflict from beam x+1 direction can be ignored. When the sensing occurs based on the beam x only, the conflict from beam x=1 direction would be more serious than the conflict from beam x.

The transmitting UE (UEA) selects the resources for SL-PRS2 with the beam 2 direction based on the reserved resources with the beam x+1 direction in the sending window. The beam x+1 direction is nearby the opposite direction of the beam 2. The transmitting UE (UEA) receives the signals in the sensing window with the beam x+1 and obtains the reserved resource in the selection window. When selecting resources in the selection window, the transmitting UE (UEA) makes the selections to avoid the conflict with these reserved resources for the resource selection of SL-PRS2.

### Example 3—Sensing Procedure and Transmission of SL-PRS1 Based on Tx Beam Group

In this example, the sensing beam adopts one direction and the transmitting beam adopts multiple directions. Thus, the sensing beam and the transmitting beam have a 1:M relationship. In this example, the transmitting UE (TxUE) operates based on the Tx beam information and is (pre-) configured with the direction of the Tx beam to RxUE. Then, the transmitting UE (TxUE) obtains the sensing beam direction that is same, opposite, or in another relationship with regard to the Tx beam direction. The transmitting UE (TxUE) can also obtain the one or more nearby beam directions of the Tx beam. Before sending SL-PRS1, the transmitting UE (TxUE) proceeds the sensing and selection procedure based on the sensing beams. The one or more nearby Tx beams can be named as a TBG (Tx Beam Group) which contains N Tx beams. And the beams in a TBG have similar space relations. Based on the sensing procedure, the transmitting UE (TxUE) sends the SL-PRSs to one or more RxUEs with beam(s) in the Tx Beam Group. Different and/or same wide beams can be contained in a TBG. The beams in a TBG can be overlapped in space.

The TBG can be transmitted from LMF to the base station, and/or the base station to UE, and/or UE to the base station, and/or the base station to another base station, and/or UE to LMF, and/or UE to UE. The TBG can be defined or (pre-) configured in the higher layer (at least one of RRC layer, SL LPP, PC5-RRC, PC5-S, MAC layer or application layer) or physical layer (1-st SCI, 2-ed SCI, SCI for SL-PRS or MAC CE).

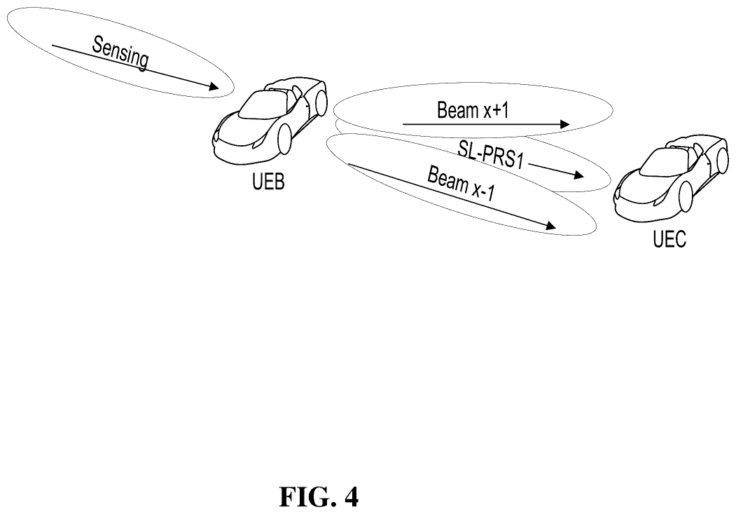

For example, as shown in FIG. 4, the transmitting UE (UEB) sends the SL-PRS1 to the receiving UE (UEC) with the Tx Beam Group which includes Beam x+1, Beam x, Beam x−1. The receiving UE (UEC) is not in the center of beam of SL-PRS1 or is moving fast. If the transmitting UE (UEB) transmits SL-PRS1 only with the beam direction corresponding to SL-PRS1, the reception at the receiving UE (UEC) may be not good because of the movement. When the transmitting UE (UEB) selects the resources for SL-PRS2 with the Tx Beam Group directions, the UEC can receive the SL-PRS based on the best receive beam direction among the TX Beam Group directions.

For example, the TxUE sends SL-PRS with one or more beams in the Tx beam group. The TxUE can perform the resource allocation based on the opposite and/or same beam direction. For example, the TxUE sends SL-PRS1 to UEB with the beam1. The resource allocation is based on the opposite and/or same beam to or as the beam 1. The sending UE can send information to multiple UEs. In addition to sending to UEB, it can also send information to UEC on different beams or at different times. In the example, TxUE uses different transmission beams to send to UEB and UEC respectively, and then the two transmission beams are in the same group. At this time, their resource selection can use the same sensing beam. In the example, when the TxUE wants to send SL-PRS2 to UEC with one or more beams which are included in the Tx Beam Group, the resource allocation can also be performed based on the the beam that is opposite and/or same with regard to the direction of beam1. When the TxUE performs the resource allocation, the higher layer provides a Tx beam direction and/or a TBG. The actual beam used for sending the sidelink transmission to another UE is one or more of the beams in the TBG.

### Example 4—Sensing Procedure Based on Rx Beam Group and Transmission of SL-PRS1 Based on Tx Beam Group

In this example, the sensing beam adopts multiple directions and the transmitting beam adopts multiple directions. Thus, the sensing beam and the transmitting beam have a N:M relationship. In this example, the transmitting UE (TxUE) operates based on the Tx beam information and is (pre-) configured with the direction of the Tx beam to RxUE. Then, the transmitting UE (TxUE) obtains the sensing beam direction that is same, opposite, or in another relationship with regard to the Tx beam direction. The transmitting UE (TxUE) can also obtain the one or more nearby beam direction of the sensing beam. Then, the transmitting UE (TxUE) proceeds the sensing and selection procedures based on one or more of these beams.

The one or more nearby Rx beams can be referred to as a RBG (Rx Beam Group) which contains N Rx beams. And the beams in a RBG have similar space relations. The sensing procedure can be based on one or more beams in the Rx Beam Group. Since the RBG includes multiple beams, the sensing procedure can be considered as being based on the wide beams. A RBG can be also seen as one or more wide beam(s) which corresponds to one or more combinations of some beams. The one or more nearby Tx beams can be referred to as a TBG (Tx Beam Group) which contains N Tx beams. The beams in the TBG have similar space relations to one another. Based on the sensing procedure, the transmitting UE (TxUE) sends the SL-PRSs to one or more RxUEs with beam(s) in the Tx Beam Group.

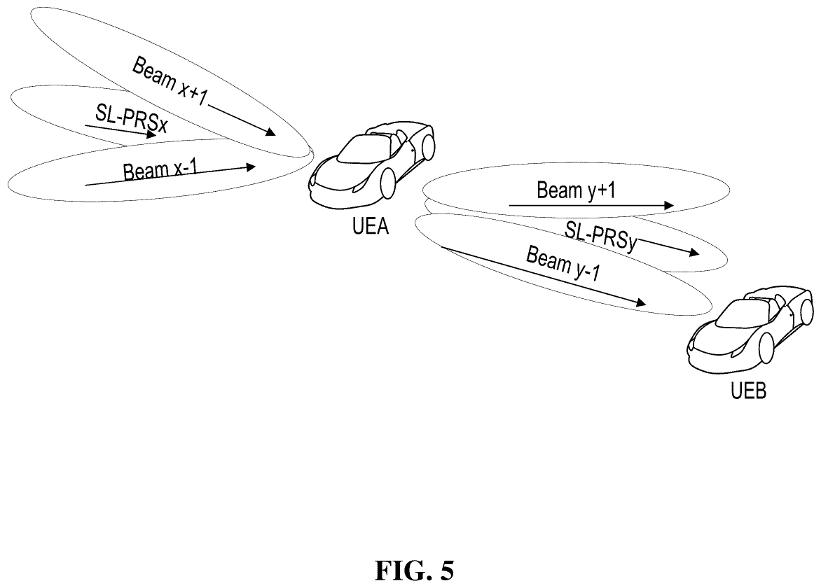

For example, as shown in FIG. 5, the transmitting UE (UEA) sends SL-PRS (SL-PRSy) to the receiving UE (UEB) with the Tx Beam Group, and proceeds the sensing procedure with the Rx Beam Group. As discussed above, by using the TBG and RBG, it is possible to avoid conflicts and can improve the reception efficiency at UEC.

In some implementations of the disclosed technology, the TxUE sends SL-PRS with one or more of the Tx beam groups. The TxUE can proceed the resource allocation based on the one or more beams in RBG. The TxUE (UEA) sends SL-PRS1 to UEB with the beam1 which is a beam in a TBG. The resource allocation is based on one or more beams in RBG. When the TxUE sends SL-PRS2 to UEC with one or more beams which are included in the Tx Beam Group, the resource allocation can also be performed based on the one or more beams in RBG. When the TxUE performs the resource allocation, the higher layer provides Tx beam information and/or a Tx beam direction and/or a TBG. The Tx beam information from the higher layer includes at least one of the Tx associated beams (one or more beams in one or more TBGs). The actual beam used for sending the sidelink transmission to another UE is one or more of the beams in the TBGs. In the example, the sensing which is performed based on the RBG is also associated with a TBG. The resource allocation based on the RBG can be used for one or more beams transmission in the TBG.

In some implementations of the disclosed technology, the Tx beam information and/or the Rx beam information and/or the selection information is obtained from physical layer, and the physical layer is at least one of 1-st SCI, 2-ed SCI, SCI for SL-PRS or MAC CE. In the example, a TxUE sends SL-PRS1 to RxUE with beam 1 in slot n−3, and the TxUE sends SL-PRS2 to the RxUE at slot n+3. Before sending the SL-PRS2, the TxUE receives a SCI or another notice message which notify the beam information and/or the changes of beam information. In some examples, TxUE sends SL-PRS2 with a new beam based on the SCI or another notice message. In some examples, the new beam may be not same as the beam1.

In some implementations of the disclosed technology, the TxUE sends SL-PRS as indicated in the SCI. The SCI contains the notice message such as the beam information (such as beam direction(s)) of transmission resource. The transmission beam may refer to the beam used for the present transmission, next transmission, or any other transmission.

For example, the TxUE sends SL-PRS as indicated in the SCI. One bit in SCI indicates whether the beam direction changes or not for the next transmission. When the bit is 1, it indicates that the beam direction has been changed. When the bit is 0, it indicates that the beam has not been changed and that the next transmission would be performed based on the same beam direction as this time. In this patent document, the beam direction can be referred to as beam or beam information.

In the example, the beam direction is represented using the 1-bit indicator in the SCI sent by UEA. In this case, UEB is periodically sending SL-PRS to UEA. When UEB receives the 1-bit indicator with 1, then the UEB can do one of the following procedures:
Case 1: Triggering the resource selection mechanism.

For example, UEB will resend and modify the sensing and transmitted beam directions accordingly to the adjacent beam directions of the original beam direction.
Case 2: UEB continues to use the time and frequency domain resource location, but the beam direction follows the beam direction feedback from UEA, such as adjacent beam directions in the original beam direction.
Case 3: UEB will not make any modifications, and resource selection will only be carried out after the number of reserved transfers in this cycle has ended with a count of 0.

For example, a UE sends SL-PRS with SCI indicated. One bit in SCI to indicate the beam sweeping for another UE. For example, the UE sends SL-PRS to another UE always with beam1, and at the slot n, the UE uses the bit to notify the change of the transmission beam. Then, the RxUE can perform the beam sweeping, and find a new beam to receive the SL-PRS which is transmitted from the TxUE.

In some implementations, after performing the sensing procedure, the resource set to be used for the sidelink transmission to the RxUE is selected by the TxUE. In some implementations, the resource set is selected by a selecting beam which is unrelated with a transmitting beam obtained from the transmitting beam information. In some implementations, the selecting beam has a spatial relationship that is orthogonal or approximately orthogonal with regard to a Tx beam. In some implementations, the resource set is selected without considering the conflicts in time-frequency domain. In some implementations, the resource set is selected by selecting beams which are related with a transmitting beam. In some implementations, the selecting beam has a spatial relationship that is same as, opposite to, approximately same as, or approximately opposite to a transmitting beam. In some implementations, the resource set is selected by considering conflicts in time-frequency domain.

### Example 5

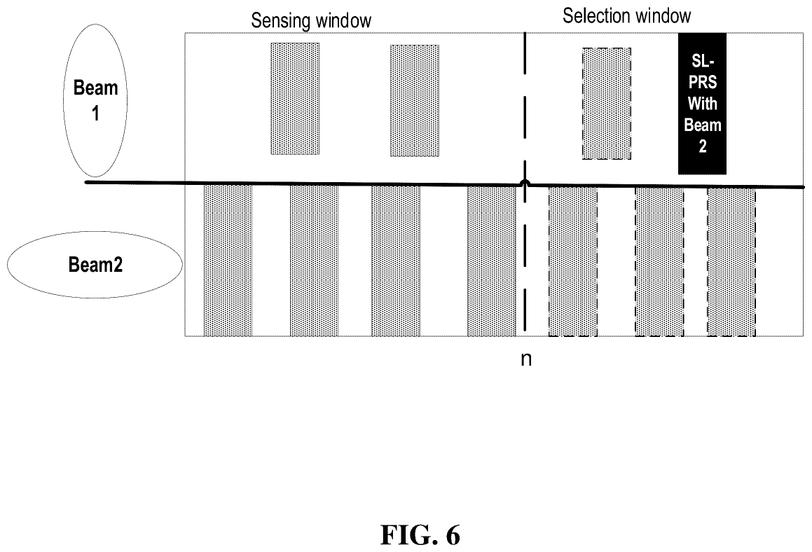

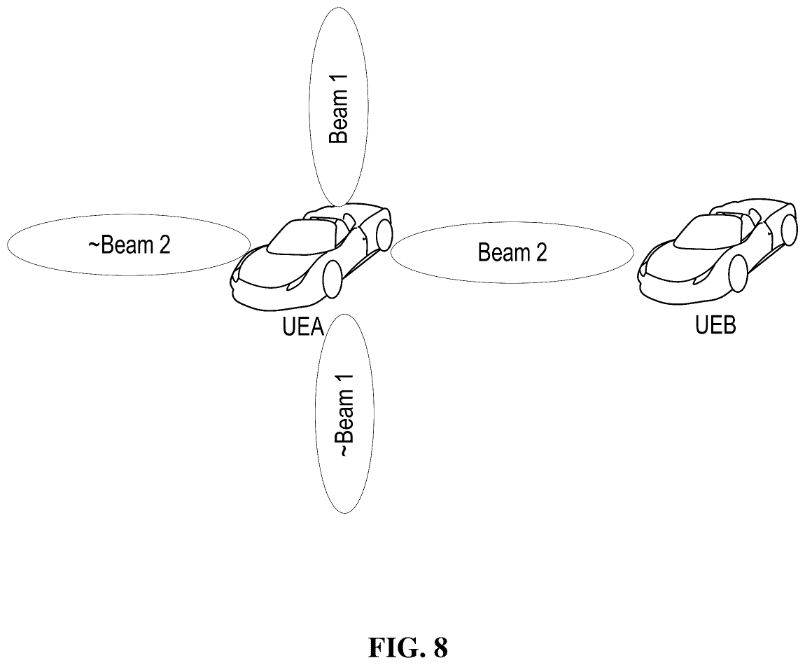

In this example, as shown in FIGS. 6 and 8, for a TxUE (UEA), beam1 and beam2 correspond to beams which are in the (part of) receiving beam information. When beam information refers to beams, beam1 and beam2 can correspond to the (part of) receiving beam information. In the example, Beam 2 has the direction that is opposite to beam 1 and is used to transmit the sidelink transmission (SL-PRS) to UEB. In sensing window, the TxUE receives some SCI/PSSCH/SL-PRS with beam 1 and/or beam 2. The reserved resources in the selection window with the beam 1 and/or beam2 are obtained. In this example, the resources in selection window are free enough and there are free resources available, which are not reserved by the resources received in sensing window. In this example, the TxUE can select the resource with less conflicts to transmit the SL-PRS with beam2. Thus, the TxUE transmits SL-PRS with the beam 2 in the selected resource area. In FIG. 6, the dotted blocks indicate reservations for future transmissions and the block indicated “SL-PRS with Beam 2′ corresponds to the resource for transmitting SL-PRS with the beam 2.

### Example 6

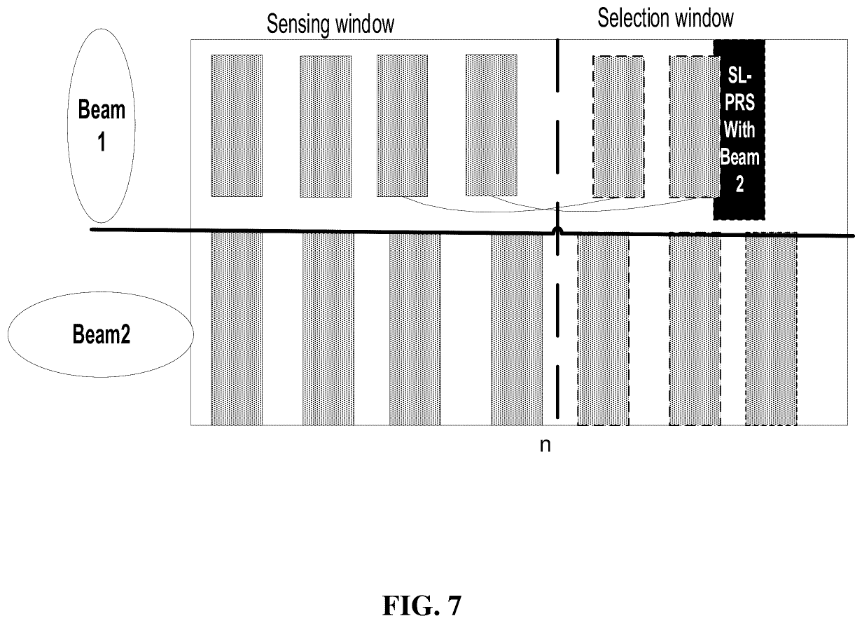

In this example, as shown in FIGS. 7 and 8, for a TxUE (UEA), beam1 and beam2 correspond to beams which are in the (part of) receiving beam information. When beam information refers to beams, beam1 and beam2 can correspond to the (part of) receiving beam information. In this example, Beam2 has the direction that is opposite to beam 1 and is used to transmit the sidelink transmission (SL-PRS) to UEB. In sensing window, the TxUE receives some SCI/PSSCH/SL-PRS with beam 1 and/or beam 2. The reserved resources in the selection window with the beam 1 and/or beam2 are obtained.

In this example of FIG. 7, as compared to the case as shown in FIG. 6, there are more resource transmissions and reservations. In this example, for the TxUE, there may be no enough resource for set A to be reported based on beam 1 and beam 2. In this case, considering the spatial relation as shown in FIG. 8, for the TxUE (UEA) and the RxUE (UEB), the time and frequency resources transmitted by beam 1 have less conflict with the resources transmitted by beam 2. Thus, in this case, the TxUE can transmit SL-PRS based on the beam 2 with the resource area reserved by beam 1 transmission as shown in FIG. 7. In FIG. 7, the dotted blocks indicate reservations for future transmissions and the block indicated “SL-PRS with Beam 2′ corresponds to the resource for transmitting SL-PRS with the beam 2. For example, while the resources are received at the slot n−3 in the sensing window for the Period ‘T’ in SCI, the resources at the slot n−3+T are the reserved resources. For the RxUE, the resources may have conflicts in the time and frequency domains, while there are less conflicts in the spatial domain. Thus, the resource may be selected only based on the spatial domain regardless of the time and frequency conflict. CR/CBR can be used to measure if there are enough resources for set A to be reported.

### Implementation Related to CR/CBR

For the legacy Sidelink Channel Busy Ratio (SL CBR) and Sidelink Channel Occupancy Ratio (SL CR) definition, there is no consideration about the beam information. For FR2 SL, there are two methods to define the CR/CBR. For the first method, all the beam directions are used to measure CR/CBR. For the second method, only some related beam directions are used to measure CR/CBR. Thus, there are more than one CR/CBR for a resource pool, which is different from the legacy scheme.

In some implementations, Channel Occupancy Ratio (CR) and the Channel Busy Ratio (CBR) are received from the higher layer. In some implementations, CR and CBR are measured by a UE. When CR and CBR are measured by the UE, the measurement procedure needs some parameters from the higher layer.

The modifications of CR/CBR definitions are suggested as follows:

### SL Channel Busy Ratio (SL CBR)

SL Channel Busy Ratio (SL CBR) measured in slot n is defined as the portion of sub-channels in the resource pool whose SL RSSI measured by the UE exceed a (pre-) configured threshold sensed over a CBR measurement window [n−a, n−1], wherein a is equal to 100 or 100·2^{μ} slots, according to higher layer parameter sl-Time WindowSizeCBR.

When UE is configured to perform partial sensing by higher layers (including when SL DRX is configured), SL RSSI is measured in slots where the UE performs partial sensing and where the UE performs PSCCH/PSSCH/SL-PRS reception within the CBR measurement window. The calculation of SL CBR is limited within the slots for which the SL RSSI is measured.

When UE is configured to receive based on FR2 beams by higher layers or physical layer, SL RSSI is measured in slots where the UE received based on a certain direction FR2 beam or where the UE received based on a certain RBG/wide direction of FR2 beams or where the UE received based on all the FR2 beam directions within the CBR measurement window.

If the number of SL RSSI measurement slots within the CBR measurement window is below a (pre-) configured threshold, a (pre-) configured SL CBR value is used.

The above modification is applicable for: RRC_IDLE intra-frequency, RRC_IDLE inter-frequency, RRC_CONNECTED intra-frequency, RRC_CONNECTED inter-frequency.

In the modification above, the slot index is based on physical slot index.

### Sidelink Channel Occupancy Ratio (SL CR)

Sidelink Channel Occupancy Ratio (SL CR) evaluated at slot n is defined as the total number of sub-channels used for its transmissions in slots [n−a, n−1] and granted in slots [n, n+b] divided by the total number of configured sub-channels in the transmission pool over [n−a, n+b].

When UE is configured to receive based on FR2 beams by higher layers or physical layer, the total number of sub-channels/frequency granularity for SL-PRS used for its transmissions in slots [n−a, n−1] and granted in slots [n, n+b] should be based on a certain direction FR2 beam or a certain RBG direction of FR2 beams or all the FR2 beam directions. Then the total number divided by the total number of configured sub-channels in the transmission pool over [n−a, n+b].

The modification is applicable for: RRC_IDLE intra-frequency, RRC_IDLE inter-frequency, RRC_CONNECTED intra-frequency, RRC_CONNECTED inter-frequency.
NOTE 1: a is a positive integer and b is 0 or a positive integer; a and b are determined by UE implementation with a+b+1=1000 or 1000·24 slots, according to higher layer parameter sl-Time WindowSizeCR, b<(a+b+1)/2, and n+b shall not exceed the last transmission opportunity of the grant for the current transmission.
NOTE 2: SL CR is evaluated for each (re) transmission.
NOTE 3: In evaluating SL CR, the UE shall assume the transmission parameter used at slot n is reused according to the existing grant(s) in slot [n+1, n+b] without packet dropping.
NOTE 4: The slot index is based on physical slot index.
NOTE 5: SL CR can be computed per priority level

In the example above, the CR/CBR is defined per beam or per beam group (TBG and/or RBG) or per wide beam/all beams.

### Implementation Related to FR2 SL CBR

For FR2 SL CBR, the CBR is defined per beam. The CBR measurement window is [n−a, n−1], wherein a is equal to m*100 or m*100·2μ slots or other value, according to higher layer parameter sl-Time WindowSizeCBR-FR2, wherein m is the max numbers of UE Tx and/or Rx beams.

For example, for the UE, there are 8 beams at the maximum from the UE capability, which means that m is 8. The higher layer parameter could be as follows:
sl-TimeWindowSizeCBR-FR2-r18 ENUMERATED {ms800, slot800} OPTIONAL, --Need M

Based on the longer CBR measurement window length, the measurement accuracy and the original probability of RSSI measurement slot within a certain beam direction can be guaranteed. If not, there may be more RSSI measurement slots number below the (pre-) configured threshold, then the CBR will be meaningless.

If the number of SL RSSI measurement slots within the CBR measurement window is below a (pre-) configured threshold, a (pre-) configured SL CBR value is used. The configured threshold should be modified.

For FR2 SL CR, the CR is defined per beam.

For a certain beam, the total number of sub-channels/frequency granularity of SL-PRS used for its transmissions in slots [n−a, n−1] and granted in slots [n, n+b] divided by the total number of configured sub-channels/frequency granularity of SL-PRS in the transmission pool over [n−a, n+b].

Note: a is a positive integer and b is 0 or a positive integer; a and b are determined by UE implementation with a+b+1=c*1000 or c*1000·2μ slots or other value, according to higher layer parameter sl-TimeWindowSizeCR-FR2, b< (a+b+1)/2, and n+b shall not exceed the last transmission opportunity of the grant for the current transmission, wherein c is the max numbers of UE Tx and/or Rx beams.

For example, for the UE, there are 8 beams at the maximum from the UE capability. That means the m is 8. So the higher layer parameter could be the flowing:
sl-Time Window SizeCR-FR2-r18 ENUMERATED {ms8000, slot8000} OPTIONAL, --Need M

Based on the longer length TimeWindowSizeCR, the measurement accuracy and the original probability of measurement slot within a certain beam direction can be guaranteed. If not, the CR will be meaningless.

FR2 SL CR and/or CRₗᵢₘᵢₜ have relation with the priority of PSCCH/PSSCH/SL-PRS/other RS/CH and/or the beam (or TBG) direction(s).

For example, if a UE is configured with higher layer parameter sl-CR-Limit and transmits PSSCH/SL-PRS in slot n with a certain beam (or TBG) direction, the UE shall ensure the following limits for any priority value k;

$${\sum }_{i \geq k} CR ( i ) \leq {CR}_{Limit} ( k )$$

where CR(i) is the CR evaluated for the beam (or TBG) direction in slot n-N for the PSSCH/SL-PRS transmissions with ‘Priority’ field in the SCI set to i, and CR_{Limit}(k) corresponds to the high layer parameter sl-CR-Limit (or one corresponds direction of the sl-CR-Limit list) that is associated with the priority value k, the beam (or TBG) direction and the CBR range which includes the CBR measured in slot n-N, where N is the congestion control processing time.

For different priority value or different beam (or TBG) directions, there are also different SL CR.

The following two cases can be suggested depending on whether CRₗᵢₘᵢₜ has a relation with the beam direction(s).
Case 1: CRₗᵢₘᵢₜ has a relation with the beam direction(s). In this implementation, the beams with different directions have corresponding CRₗᵢₘᵢₜ values.

For different beam (or TBG) directions, the nearby beams (or TBG) may be overlapped. Thus, the time-frequency resources of some nearby beams (or TBG) can be seen as having some conflicts, and the same time-frequency resources with different beams cannot be transmitted without conflicts. The legacy CRₗᵢₘᵢₜ value is not useful for each beam (or TBG) directions and some beams having relations (“related beams”) need to share the legacy CRₗᵢₘᵢₜ value. Thus, for some related beams instead of all the beams using the legacy CR limit value, the CR needs to be measured and compared with the CRₗᵢₘᵢₜ. One of the beams' CRₗᵢₘᵢₜ would be smaller than the legacy CRₗᵢₘᵢₜ value.
Case 2: CRₗᵢₘᵢₜ has no relation with the beam direction(s). In this implementation, the beams with different directions have one CRₗᵢₘᵢₜ value.

For different beam (or TBG) directions, the time-frequency resources may be seen as having no conflicts. Thus, the same time-frequency resources with different beams can be transmitted without conflicts. Thus, the legacy CRₗᵢₘᵢₜ value is also useful for each beam (or TBG) directions.

According to the FR2 SL CBR and SL CR definitions, there could be more than one CR/CBR for a UE. So CBR list and/or CR list can be introduced to contain the CR/CBR measurements.

Based on a UE's antenna configuration, the maximum number of beams is fixed, but the UE can transmit or receive the message with a wide beam which is composed of or includes a set of narrow beams. For a wide beam transmission and/or reception, the CR/CBR could be different from the legacy schemes.

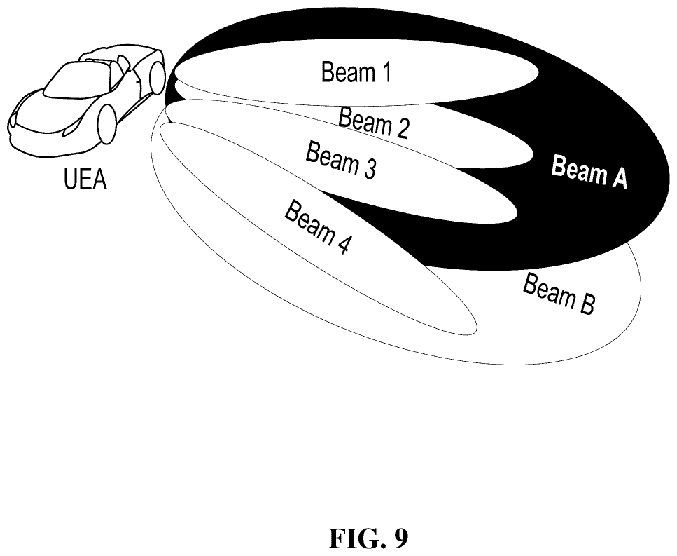

For example, in the example as shown in FIG. 9 considering FR2 SL CR, the legacy CRₗᵢₘᵢₜ value is 20%.

If UE A transmits SL-PRS1 based on a narrow beam 1, the CR measurement is based on the beam 1 which is included in the CR list and compared with CRₗᵢₘᵢₜ 20%.

If UE A transmits SL-PRS2 based on a wide beam A (TBG1 including beam 1, beam 2 and beam 3), the scheme of CR measurement is based on the beam 1, beam 2 and beam 3 respectively, it can get the CR list and then use the total measurement results compared with CRₗᵢₘᵢₜ 20%. For this case, if UEA has transmit SL-PRS1 over the 10%, based on the scheme the beam A could cover the SL-PRS1 and only less than by 10% to 20% of CRₗᵢₘᵢₜ for beam A.

If UE A transmits SL-PRS3 based on a wide beam B (TBG2 including beam 3 and beam 4), the scheme of CR measurement is based on the beam 3 and beam 4, respectively, and also compared with CRₗᵢₘᵢₜ 20%.

For example, in the example of FIG. 9 considering FR2 SL CBR, the scheme is same as the SL CR measurement. The UEA can receive SL-PRS based on a narrow beam 1, wide beam A or wide beam B. When the UEA transmits SL-PRS based on a beam or TBG, the CBR measurement can be based on the beam or RBG corresponding the TBG. The corresponding CBR or the total combination CBRs is selected based on the CBR list as the final CBR for this transmission.

For the dedicated resource pool of SL-PRS, the CR and/or CBR can be introduced. For the quality of service (QOS), the congestion control for SL only PSSCH were considered. But now for SL-PRS dedicated resource pool, there is no PSSCH and to do CR/CBR measurement should be based on the SL-PRS. Thus, a series of IEs about SL-PRS can be introduced for CR/CBR.

The modifications of IEs are suggested as follows:
sl-DefaultTxConfigIndex

Indicates the PSSCH/SL-PRS/RS or CH transmission parameters to be used by the UEs which do not have available CBR measurement results, by means of an index to the corresponding entry in sl-Tx-ConfigIndexList. Value 0 indicates the first entry in sl-Tx-ConfigIndexList. The field is ignored if the UE has available CBR measurement results.
sl-CBR-ConfigIndex

Indicates the CBR ranges to be used by an index to the entry of the CBR range configuration in sl-CBR-RangeConfigList.
sl-MCS-RangeList

Indicates the minimum MCS value and maximum MCS value for the associated MCS table(s). UE shall ignore the minimum MCS value and maximum MCS value used for table of 64QAM indicated in SL-CBR-PriorityTxConfigList-r16 if SL-CBR-PriorityTxConfigList-v1650 is present.
sl-Priority Threshold

Indicates the upper bound of priority range which is associated with the configurations in sl-CBR-ConfigIndex and in sl-Tx-ConfigIndexList. The upper bounds of the priority ranges are configured in ascending order for consecutive entries of SL-PriorityTxConfigIndex in SL-CBR-PriorityTxConfigList. For the first entry of SL-PriorityTxConfigIndex, the lower bound of the priority range is 1.
SL-CBR-PriorityTxConfigList-v1650

If included, it includes the same number of entries, and listed in the same order, as in SL-CBR-PriorityTxConfigList-r16.
sl-CBR-RangeConfigList

Indicates the list of CBR ranges. Each entry of the list indicates in SL-CBR-LevelsConfig the upper bound of the CBR range for the respective entry. The upper bounds of the CBR ranges are configured in ascending order for consecutive entries of sl-CBR-RangeConfigList. For the first entry of sl-CBR-RangeConfigList the lower bound of the CBR range is 0. Value 0 corresponds to 0, value 1 to 0.01, value 2 to 0.02, and so on.
sl-CR-Limit

Indicates the maximum limit on the occupancy ratio. Value 0 corresponds to 0, value 1 to 0.0001, value 2 to 0.0002, and so on (i.e. in steps of 0.0001) until value 10000, which corresponds to 1.
sl-CBR-PSSCH-TxConfigList

Indicates the list of available PSSCH/SL-PRS transmission parameters (such as MCS, sub-channel number, retransmission number and CR limit) configurations.
sl-TxParameters

Indicates PSSCH/SL-PRS transmission parameters.
sl-CBR-SL-PRS-TxConfigList

Indicates the list of available SL-PRS transmission parameters (such as MCS, sub-channel number, retransmission number and CR limit) configurations.

If a UE is configured with higher layer parameter sl-CR-Limit and transmits PSSCH/SL-PRS in slot n, the UE shall ensure the following limits for any priority value k;

$${\sum }_{i \geq k} CR ( i ) \leq {CR}_{Limit} ( k )$$

where CR (i) is the CR evaluated in slot n-N for the PSSCH/SL-PRS transmissions with ‘Priority’ field in the SCI set to i, and CR_{Limit}(k) corresponds to the high layer parameter sl-CR-Limit that is associated with the priority value k and the CBR range which includes the CBR measured in slot n-N, where N is the congestion control processing time.

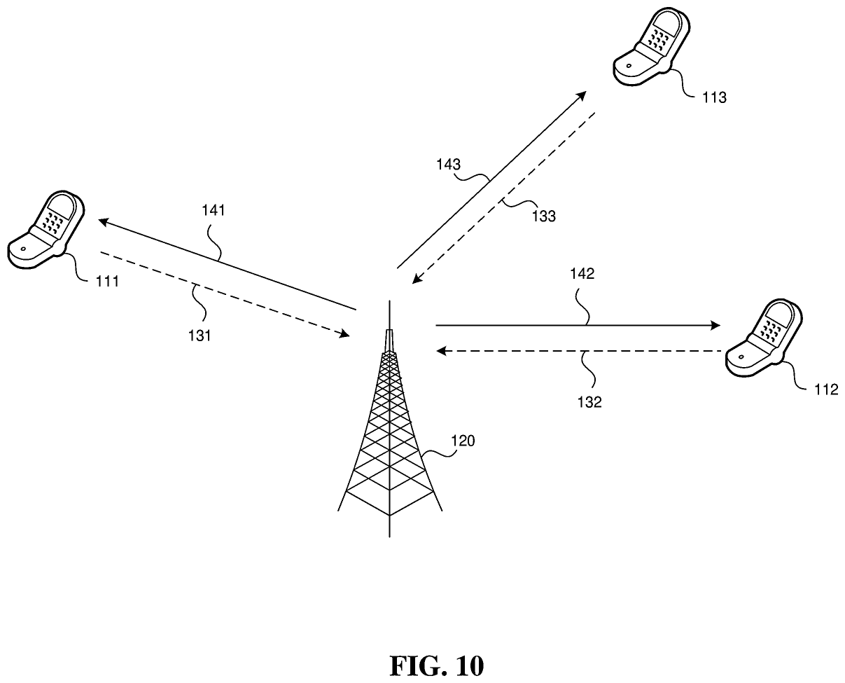

FIG. 10 shows an example of a wireless communication system (e.g., a long term evolution (LTE), 5G or NR cellular network) that includes a BS 120 and one or more user equipment (UE) 111, 112 and 113. In some embodiments, the uplink transmissions (131, 132, 133) can include uplink control information (UCI), higher layer signaling (e.g., UE assistance information or UE capability), or uplink information. In some embodiments, the downlink transmissions (141, 142, 143) can include DCI or high layer signaling or downlink information. The UE may be, for example, a smartphone, a tablet, a mobile computer, a machine to machine (M2M) device, a terminal, a mobile device, an Internet of Things (IoT) device, and so on.

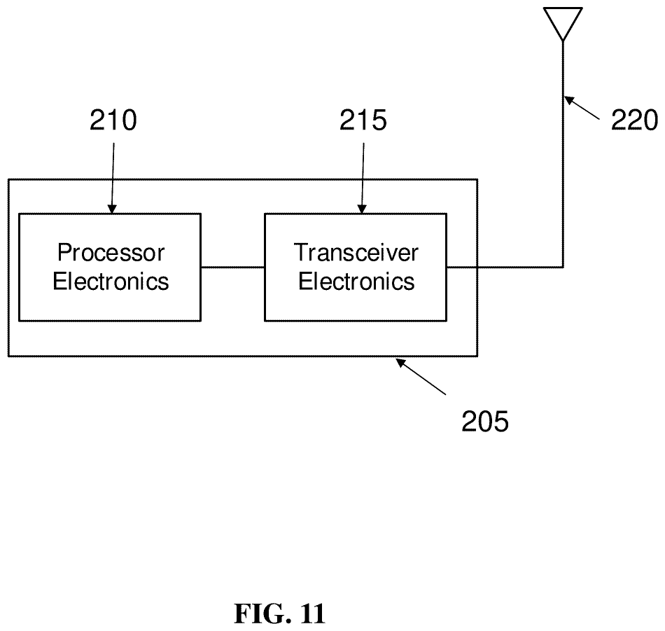

FIG. 11 is a block diagram representation of a portion of an apparatus, in accordance with some embodiments of the presently disclosed technology. An apparatus 205 such as a network device or a base station or a wireless device (or UE), can include processor electronics 210 such as a microprocessor that implements one or more of the techniques presented in this document. The apparatus 205 can include transceiver electronics 215 to send and/or receive wireless signals over one or more communication interfaces such as antenna(s) 220. The apparatus 205 can include other communication interfaces for transmitting and receiving data. Apparatus 205 can include one or more memories (not explicitly shown) configured to store information such as data and/or instructions. In some implementations, the processor electronics 210 can include at least a portion of the transceiver electronics 215. In some embodiments, at least some of the disclosed techniques, modules or functions are implemented using the apparatus 205.

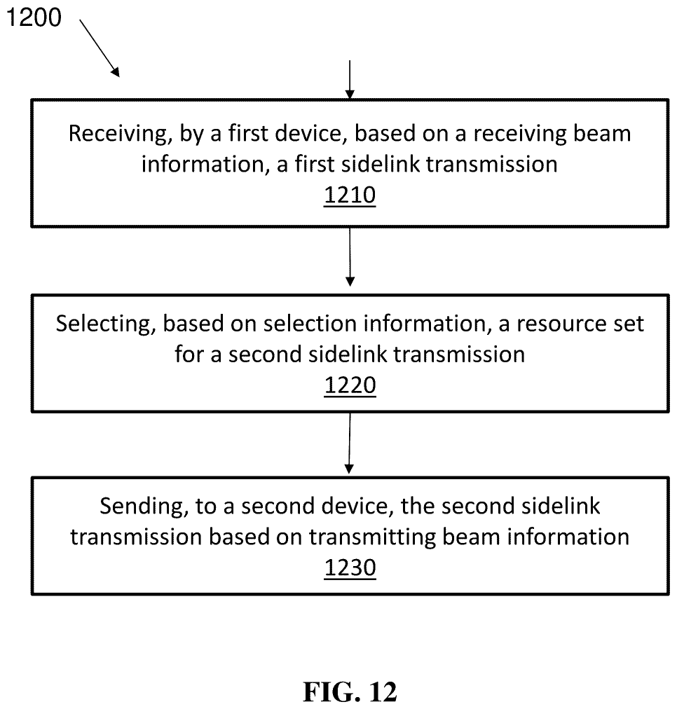

Some preferred embodiments may include the following solutions.
1. A method (e.g., method 1200 in FIG. 12) of wireless communication, comprising: receiving 1210, by a first device, based on a receiving beam information, a first sidelink transmission; selecting 1220, based on selection information, a resource set for a second sidelink transmission; and sending 1230, to a second device, the second sidelink transmission based on transmitting beam information.
2. The method of solution 1, wherein the selection information includes at least one of: a frequency domain index of sidelink positioning reference signal, a delay budget, a number of comb offset to be used for the sidelink transmission, a panel identification, a resource pool from which resources are to be reported, a priority, or a resource reservation interval.
3. The method of solution 1, wherein at least one of the receiving beam information or the transmitting beam information is obtained from at least one of a sidelink control information (SCI), a SCI indicating SL-PRS (sidelink positioning reference signals), PSSCH, PSCCH, PSSCH, SL-PRS or a downlink control information.
4. The method of solution 1, wherein at least one of the receiving beam information, the transmitting beam information, or the selection information is configured or pre-configured or predefined from a higher layer, and wherein the higher layer is at least one of a RRC layer, a SL LPP, a PC5-RRC, a PC5-S, a MAC layer, or an application layer.
5. The method of solution 1, wherein at least one of the receiving beam information, the transmitting beam information, or the selection information is from a physical layer, and wherein the physical layer is at least one of a first SCI, a second SCI, DCI3-0, a SCI for SL-PRS, or a MAC CE.
6. The method of solution 1, wherein the transmitting beam information includes information on one or more beams in a transmission beam group and the transmission beam information is associated with actual transmission beams.
7. The method of solution 6, further comprising: performing a sensing procedure based on sensing related beam information.
8. The method of solution 7, wherein the sensing related beam information includes a beam having a direction that is opposite to and/or same as the transmitting beam in the transmission beam group.
9. The method of solution 7, wherein the sensing related beam information include multiple beams included in a reception beam group including a beam having a direction that is opposite to and/or same as the transmitting beam in the transmission beam group.
10. The method of solution 1, wherein at least one of the transmitting beam information and/or the receiving beam information is received from the second device or other devices.
11. The method of solution 1, wherein the receiving beam information has a relation with the transmitting beam information.
12. The method of solution 1, wherein the receiving beam information contains all beam directions received during a sensing window.
13. The method of solution 1, wherein the receiving beam information contains partial directions that is a part of all beam directions received during a sensing window.
14. The method of solution 1, further comprising: performing a sensing procedure based on sensing related beam information.
15. The method of solution 14, wherein the sensing related beam information has a relation with the transmitting beam information.
16. The method of solution 14, wherein the sensing related beam information includes information on one or more receiving beams having particular directions with respect to a transmitting beam included in the transmitting beam information.
17. The method of solution 14, wherein the sensing related beam information includes a beam having a direction that is opposite to and/or same as the transmitting beam.
18. The method of solution 14, wherein the sensing related beam information include multiple beams included in a reception beam group including a beam having a direction that is opposite to and/or same as the transmitting beam.
19. The method of any one of solutions 14 to 18, wherein the sensing related beam information is used for the second sidelink transmission which is sent to the second device in an additional beam direction included in a transmission beam group including a beam having a direction same as that of the transmitting beam.
20. The method of any one of solutions 14 to 18, wherein the sensing related beam information is used for the second sidelink transmission sent to the second device in a combined beam direction included in a transmission beam group including a beam having a direction same as that of the transmitting beam.
21. The method of any of solutions 14 to 18, wherein the sensing related beam information is used for another sidelink transmission which is sent to another device in an additional beam direction included in a transmission beam group including a beam having a direction same as that of the transmitting beam or a combined beam direction included in the transmission beam group.
22. The method of solution 1, further comprising: performing, by the first device, a sensing procedure based on sensing related beam information; and reporting, by the first device, the selected resource set to a higher layer.
23. The method of solution 1 or 22, wherein the resource set is selected by a selecting beam which is unrelated with a transmitting beam obtained from the transmitting beam information.
24. The method of solution 23, wherein the selecting beam has a spatial relationship that is orthogonal or approximately orthogonal with regard to a transmitting beam.
25. The method of solution 24, wherein the resource set is selected without considering conflicts in time-frequency domain.
26. The method of solution 22, wherein the resource set is selected by selecting beams which are related with a transmitting beam.
27. The method of solution 26, wherein the selecting beam has a spatial relationship that is same as, opposite to, approximately same as, or approximately opposite to a transmitting beam.
28. The method of solution 27, wherein the resource set is selected by considering conflicts in time-frequency domain.
29. The method of solution 18, wherein the sending the second sidelink transmission includes transmitting a sidelink positioning reference signal (SL-PRS) using resources reserved by the receiving beam information or the transmitting beam depending on a conflict level of time and frequency resources.
30. The method of solution 1, wherein the resource set for the second sidelink transmission are selected further based on channel occupancy ratio (CR) and channel busy ratio (CBR).
31. The method of solution 1, wherein the second sidelink transmission corresponds to SL-PRS and wherein the second sidelink transmission is sent based on channel occupancy ratio (CR) and channel busy ratio (CBR).
32. The method of solution 1, wherein channel occupancy ratio (CR) and channel busy ratio (CBR) are defined based on beam information provided by a higher layer or a physical layer, the beam information including the receiving beam information or the transmitting beam information.
33. The method of solution 30, wherein the channel occupancy ratio and the channel busy ratio are received from a higher layer.
34. The method of solution 30, wherein the channel occupancy ratio and the channel busy ratio are measured by the first device.
35. The method of solution 34, wherein the measuring is performed by the first device configured to use receiving a FR2 beam with a certain direction, FR2 beams with certain reception beam group, a FR2 wide beam, or FR2 beams with all directions.
36. The method of solution 30, wherein at least one of the channel occupancy ratio or the channel busy ratio is defined per a beam.
37. The method of solution 30, wherein at least one of the channel occupancy ratio (CR) and/or a limit of the CR (CRₗᵢₘᵢₜ) have relations with a priority value of at least one of PSCCH, PSSCH, SL-PRS, or other RS/CH, and/or has relation with beam directions.
38. The method of solution 30, wherein at least one of a list of channel busy ratio (CBR) including multiple CBR measurements or a list of channel occupancy ratio (CR) including multiple measures is configured for the first device.
39. The method of solution 34, wherein a channel busy ratio (CBR) measurement window is set based on maximum numbers of transmitting beams and receiving beams that are provided from a higher layer.
40. A wireless communication apparatus comprising a processor configured to implement a method recited in any of above solutions.
41. A computer storage medium having code stored thereupon, the code, upon execution by a processor, causing the processor to implement a method recited in any of above solutions.

The example embodiments above are performed by a first device which sends a sidelink transmission to a second device. Those skilled in the art can understand that the suggested embodiments can be modified and applied to the second device that receives the sidelink transmission from the first device. For example, the suggested embodiments can include a method of wireless communication comprising receiving, by the second device, from the first device, the second sidelink transmission using the selected resource set that is selected as described in this patent document.

The disclosed and other embodiments, modules and the functional operations described in this document can be implemented in digital electronic circuitry, or in computer software, firmware, or hardware, including the structures disclosed in this document and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few examples and implementations are disclosed. Variations, modifications, and enhancements to the described examples and implementations and other implementations can be made based on what is disclosed.

1. A method of wireless communication, comprising:
receiving, by a first device, based on a receiving beam information, a first sidelink transmission;
selecting, based on selection information, a resource set for a second sidelink transmission; and
sending, to a second device, the second sidelink transmission based on transmitting beam information,
wherein the selection information includes at least one of: a frequency domain index of sidelink positioning reference signal, a delay budget, a number of comb offset to be used for the second sidelink transmission, a panel identification, a resource pool from which resources are to be reported, a priority, or a resource reservation interval.

2. The method of claim 1, wherein at least one of the receiving beam information or the transmitting beam information is obtained from at least one of a sidelink control information (SCI), a SCI indicating SL-PRS (sidelink positioning reference signals), PSSCH, PSCCH, PSSCH, SL-PRS or a downlink control information.

3. The method of claim 1, wherein at least one of the receiving beam information, the transmitting beam information, or the selection information is i) configured or pre-configured or predefined from a higher layer, and wherein the higher layer is at least one of a RRC layer, a SL LPP, a PC5-RRC, a PC5-S, a MAC layer, or an application layer, or ii) from a physical layer, and wherein the physical layer is at least one of a first SCI, a second SCI, DCI3-0, a SCI for SL-PRS, or a MAC CE.

4. The method of claim 1, wherein the transmitting beam information includes information on one or more beams in a transmission beam group and the transmitting beam information is associated with actual transmission beams, wherein the method further comprises: performing a sensing procedure based on sensing related beam information,
wherein the sensing related beam information includes i) a beam having a direction that is opposite to and/or same as a transmitting beam in the transmission beam group, or ii) multiple beams included in a reception beam group including a beam having a direction that is opposite to and/or same as the transmitting beam in the transmission beam group.

5. The method of claim 1, wherein at least one of the transmitting beam information or the receiving beam information is received from the second device or other devices, or
wherein the receiving beam information has a relation with the transmitting beam information, or
wherein the receiving beam information contains all beam directions received during a sensing window, or partial directions that is a part of all beam directions received during a sensing window.

6. The method of claim 1, further comprising:
performing a sensing procedure based on sensing related beam information,
wherein the sensing related beam information includes i) information on one or more receiving beams having particular directions with respect to a transmitting beam included in the transmitting beam information, ii) a beam having a direction that is opposite to and/or same as the transmitting beam, or iii) multiple beams included in a reception beam group including a beam having a direction that is opposite to and/or same as the transmitting beam.

7. The method of claim 6, wherein the sensing related beam information has a relation with the transmitting beam information, or
wherein the sensing related beam information is used for the second sidelink transmission sent to the second device in an additional beam direction included in a transmission beam group including a beam having a direction same as that of the transmitting beam, in a combined beam direction included in a transmission beam group including a beam having a direction same as that of the transmitting beam, or
wherein the sensing related beam information is used for another sidelink transmission which is sent to another device in an additional beam direction included in a transmission beam group including a beam having a direction same as that of the transmitting beam or a combined beam direction included in the transmission beam group.

8. The method of claim 1, further comprising:
performing, by the first device, a sensing procedure based on sensing related beam information; and
reporting, by the first device, a selected resource set to a higher layer, and
wherein the resource set is selected by selecting beams which are related with a transmitting beam and has a spatial relationship that is same as, opposite to, approximately same as, or approximately opposite to a transmitting beam, wherein the resource set is selected by considering conflicts in time-frequency domain.

9. The method of claim 1, wherein the resource set is selected by a selecting beam which is unrelated with a transmitting beam obtained from the transmitting beam information and has a spatial relationship that is orthogonal or approximately orthogonal with regard to a transmitting beam, wherein the resource set is selected without considering conflict in time frequency domain.

10. The method of claim 1, wherein the sending the second sidelink transmission includes transmitting a sidelink positioning reference signal (SL-PRS) using resources reserved by the receiving beam information or the transmitting beam information depending on a conflict level of time and frequency resources, or wherein the second sidelink transmission corresponds to SL-PRS and wherein the second sidelink transmission is sent based on channel occupancy ratio (CR) and channel busy ratio (CBR).

11. The method of claim 1, wherein the resource set for the second sidelink transmission are selected further based on channel occupancy ratio (CR) and channel busy ratio (CBR), or
wherein the channel occupancy ratio (CR) and the channel busy ratio (CBR) are defined based on beam information provided by a higher layer or a physical layer, the beam information including the receiving beam information or the transmitting beam information.

12. The method of claim 11, wherein the channel occupancy ratio and the channel busy ratio are received from a higher layer, or,
wherein the channel occupancy ratio and the channel busy ratio are obtained from a measuring by the first device, the measuring performed by the first device configured to use receiving a FR2 beam with a certain direction, FR2 beams with certain reception beam group, a FR2 wide beam, or FR2 beams with all directions, or
wherein a channel busy ratio (CBR) measurement window is set based on maximum numbers of transmitting beams and receiving beams that are provided from a higher layer.

13. The method of claim 11, wherein at least one of the channel occupancy ratio or the channel busy ratio is defined per a beam, or wherein at least one of the channel occupancy ratio (CR) and/or a limit of the CR (CRₗᵢₘᵢₜ) have relations with a priority value of at least one of PSCCH, PSSCH, SL-PRS, or other RS/CH, and/or has relation with beam directions, or wherein at least one of a list of channel busy ratio (CBR) including multiple CBR measurements or a list of channel occupancy ratio (CR) including multiple measures is configured for the first device.

14. A wireless communication apparatus comprising a processor configured to:
receive, by a first device, based on a receiving beam information, a first sidelink transmission;
select, based on selection information, a resource set for a second sidelink transmission; and
send, to a second device, the second sidelink transmission based on transmitting beam information,
wherein the selection information includes at least one of: a frequency domain index of sidelink positioning reference signal, a delay budget, a number of comb offset to be used for the second sidelink transmission, a panel identification, a resource pool from which resources are to be reported, a priority, or a resource reservation interval.

15. The wireless communication apparatus of claim 14, wherein at least one of the receiving beam information or the transmitting beam information is obtained from at least one of a sidelink control information (SCI), a SCI indicating SL-PRS (sidelink positioning reference signals), PSSCH, PSCCH, PSSCH, SL-PRS or a downlink control information.

16. The wireless communication apparatus of claim 14, wherein the transmitting beam information includes information on one or more beams in a transmission beam group and the transmitting beam information is associated with actual transmission beams, wherein the processor is further configured to perform a sensing procedure based on sensing related beam information,
wherein the sensing related beam information includes i) a beam having a direction that is opposite to and/or same as a transmitting beam in the transmission beam group, or ii) multiple beams included in a reception beam group including a beam having a direction that is opposite to and/or same as the transmitting beam in the transmission beam group.

17. The wireless communication apparatus of claim 14, wherein at least one of the transmitting beam information or the receiving beam information is received from the second device or other devices, or
wherein the receiving beam information has a relation with the transmitting beam information, or
wherein the receiving beam information contains all beam directions received during a sensing window, or partial directions that is a part of all beam directions received during a sensing window.

18. The wireless communication apparatus of claim 14, wherein the processor is further configured to perform a sensing procedure based on sensing related beam information,
wherein the sensing related beam information includes i) information on one or more receiving beams having particular directions with respect to a transmitting beam included in the transmitting beam information, ii) a beam having a direction that is opposite to and/or same as a transmitting beam, or iii) multiple beams included in a reception beam group including a beam having a direction that is opposite to and/or same as the transmitting beam.

19. The wireless communication apparatus of claim 14, wherein the resource set for the second sidelink transmission are selected further based on channel occupancy ratio (CR) and channel busy ratio (CBR), or
wherein the channel occupancy ratio (CR) and the channel busy ratio (CBR) are defined based on beam information provided by a higher layer or a physical layer, the beam information including the receiving beam information or the transmitting beam information.

20. The wireless communication apparatus of claim 19, wherein the channel occupancy ratio and the channel busy ratio are received from a higher layer, or
wherein the channel occupancy ratio and the channel busy ratio are obtained from a measuring by the first device, the measuring performed by the first device configured to use receiving a FR2 beam with a certain direction, FR2 beams with certain reception beam group, a FR2 wide beam, or FR2 beams with all directions, or
wherein a channel busy ratio (CBR) measurement window is set based on maximum numbers of transmitting beams and receiving beams that are provided from a higher layer.
